(19) United States
(12) Patent Application Publication
(10) Pub. No.: US 2011/0092349 A1
(43) Pub. Date: Apr. 21, 2011

(54) DEEP ROLLING HEAD

(75) Inventors: Alfred Heimann, Aachen (DE); Daniel Knipping, Waldfeucht (DE)

(73) Assignee: Hegenscheidt-Mfd GmbH & Co. KG, Erkelenz (DE)

(21) Appl. No.: 12/996,328

(22) PCT Filed: Jun. 3, 2009
(86) PCT No.: PCT/DE2009/000784

§ 371 Date: Dec. 3, 2010

(30) Foreign Application Priority Data
Jun. 5, 2008 (DE) 20 2008 007 563.7

(51) Int. Cl. F16C 13/00

(52) U.S. Cl. 492/57

(57) ABSTRACT

The invention concerned is a deep rolling head (1) of a deep rolling unit for deep rolling of radii or recesses (4) at the bearing trunnions (5) of crankshafts with the help of work rollers (3) which are held on both sides of the contact point in the direction of circumference (6) at the deep rolling head with the bearing trunnion (5) from cages (7) and can be rotated freely in there, whereby the cages (7) are held at the deep rolling head (1) by cage retainers (10). At least one cage (7) of the deep rolling head (1) is designed as cage roller (9) and a stopping device in the form of a holding plate (14) is provided for the work roller (3).

The invention concerned is a deep rolling head of a deep rolling unit for deep rolling of radii or recesses at the bearing trunnions of crankshafts with the help of work rollers which are held on both sides of the contact point in the direction of circumference at the deep rolling head with the bearing trunnion from cages and can be rotated freely in there, whereby the cages are held at the deep rolling head by cage retainers.

A deep rolling head of this sort is known, for example, from the European patent application. EP 1 318 889. The deep rolling head in question has work rollers which are held on both sides of the contact point in the direction of circumference of a crankshaft to be machined with the bearing trunnion from cages and can be rotated freely in there. When this is done, the cages themselves are held at the deep rolling head by L-shaped holders. The L-shaped holders can be adjusted. To reduce any friction between the work rollers and the cages, the cages in question are made of plastic.

The design of the cages is known, for example, from the German utility patent 200 23 033.6. In this case a so-called double cage is meant; that is, if the contact surface between the work rollers and the work roller cage is worn, the cage is turned around in the deep rolling head and a contact surface with the same design at the other end of the cage takes over the holding and guidance of the work roller until this guiding surface is also worn.

To reduce the wear at the cage, the German patent application D 100 45 258 stipulates, for example, that at least a portion of the cage or section of the concave recess where the work roller is guided be made of a material which releases solid body lubricant onto the work roller.

To summarise, it still needs to be noted that the cages have the task of holding the work rollers at the deep rolling head. Furthermore, the rear cage (this being the cage that is facing the crankshaft rotation) must provide the forming force for the deep rolling in the direction of circumference and the frictional force between the work roller and the guide roller for the work roller in the deep rolling head. This frictional force amounts to about 10 percent of the contact force of the deep rolling head under the deep rolling force.

The rear, driving cage wears due to the friction of the work roller. The wear causes the contact surface between the cage and the work roller to gradually take on the shape of the work roller. In the event of very heavy wear, the work roller can even become stuck in the cage. In any case, the required angle mobility of the work roller will be restricted and the load on the work roller will increase if the changing geometric ratios of the crankshaft make an angle adjustment of the work roller necessary.

It is the function of this invention to reduce the friction between the work roller and the cage.

To solve this problem, the driven rear cage is replaced by a cage roller and a stopping device is provided for the holding of the work roller at the deep rolling head. To reduce friction, the cage roller is equipped as a roller bearing. This equipment has the distinct advantage of being quite economical, since roller bearings are produced in large-scale series. Their outer bearing surfaces are hardened and present low-wear contact surfaces to the work roller applied to them. Serially produced roller bearings are also available with permanent lubrication and covering discs, which make the roller bearings unsusceptible to dirt. All in all, the result is a reduction in friction, an increase of service life and the elimination of settings at the deep rolling head.

The cage roller should optimally be cylindrical. concave shape of the cage roller is also a possibility to get better contact ratios to the work roller. Finally, it should also be possible to move the cage roller laterally to a limited extent so that it can adjust to the changing geometric ratios of the bearing trunnion during the deep rolling process. Other benefits of the invention's advantageous design features are detailed below in sub-claims 2 to 10.

The invention is described in detail below using a design example.

The illustrations are greatly simplified and not to scale.

FIG. 1 Side view of a deep rolling head

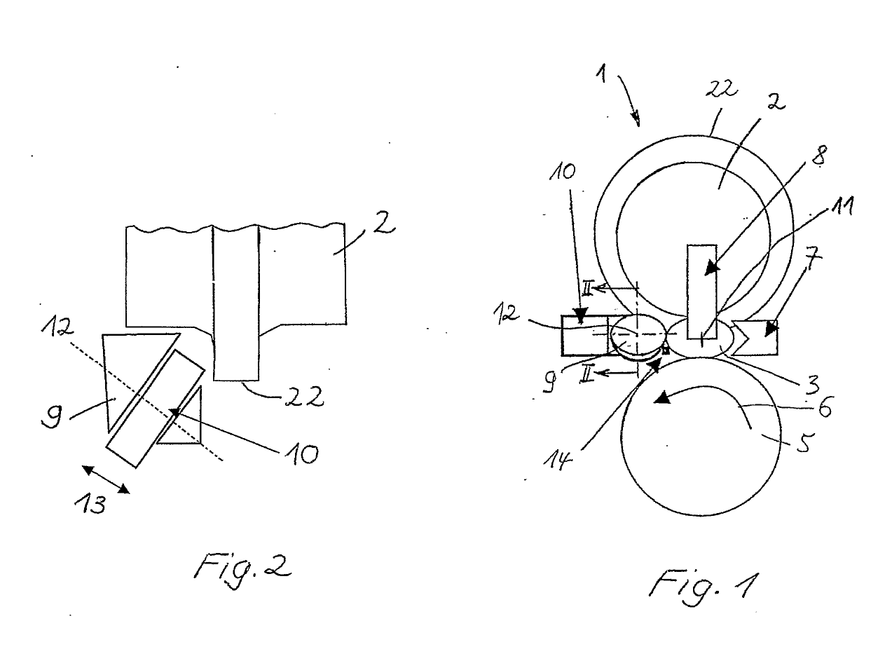

FIG. 2 A section along the line II-II of FIG. 1

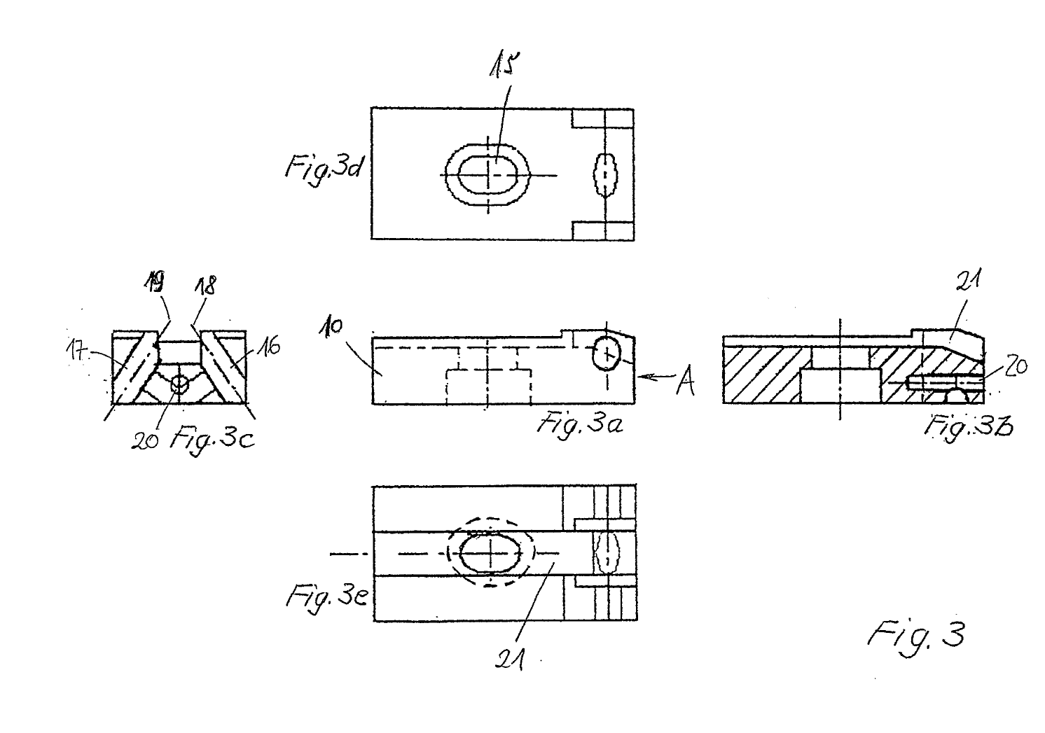

FIG. 3 Multiple views of a cage retainer

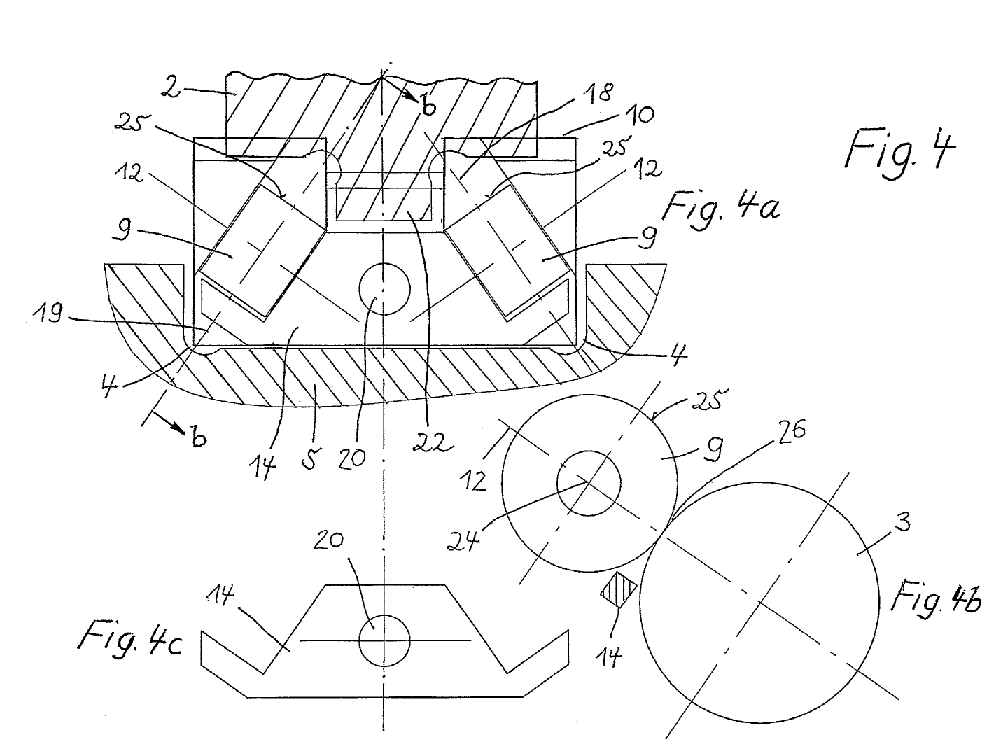

FIG. 4 The design of a part of the deep rolling tool

A deep rolling head 1 contains a guide roller 2, which has been mounted so that it can be rotated in its housing (not shown). Work roller 3 is supported by guide roller 2 and is intended to deep roll a radius or a recess 4 (FIG. 4a) at the bearing trunnion 5 of a crankshaft (not shown). Work roller 3 (generally there are two work rollers 3 in a deep rolling head 1) is held and guided on both sides of the direction of circumference 6 and cages 7. Besides this, work rollers 3 at deep rolling head 1 are also held by side holding plates 8.

In the present case, a cage roller is intended instead of the rear driven cage. The cage roller 9 has been mounted so that is can be rotated in a cage retainer 10, whereby rotational axes 11 and 12 of the work roller 3 or the cage roller 9 take up nearly the same space. In addition to its mounting, which makes it possible to rotate around its rotational axis 12, cage roller 9 can also be moved by a small amount 13 in the axial direction. While cage roller 9 is fixed in cage retainer 10 with a pin (not shown), holding plate 14 of work roller 3 provides the necessary protection against falling out of the deep rolling head 1.

FIG. 3 shows different views of cage retainer 10. Of these, FIG. 3a shows a side view and FIG. 3b a longitudinal section through cage retainer 10. FIG. 3d shows cage retainer 10 from below and FIG. 3e from above. FIG. 3c shows a front view of cage retainer 10 from direction A. A graduated oblong slot 15 is provided for the fixing of cage retainer 10 at deep rolling head 1. Two cage rollers 9 can be arranged in the two recesses 16 and 17, which are positioned at an angle, whereby the centre axes 18 and 19 have nearly the same inclination as rotational axis 11 of the work roller 3. Finally, bore hole 20 is used to fix holding plate 14 to cage retainer 10. The longitudinal groove 21 permits the guide roller 2 to move with its circumferential flange 22.

FIG. 4a is a front view of cage roller 9 along the line II-II of FIG. 1. FIG. 4b is produced if a cross section is made though the centre axis 19 and this is folded over in direction b-b. As can be seen, cage roller 9 has a cylindrical shape and is mounted so that it can be rotated in its centre 24 on a cylindrical pin (not shown) in cage retainer 10. In accordance with a preferred version, cage roller 9 is formed from a serially produced axial roller bearings Besides the cylindrical surface 25, as can be especially seen in FIG. 4a, cage roller 9 can deviate from this by having concave recessed circumferential shapes along the centre axis 18 or 19. Work roller 3 is supported on cage roller 9 in contact area 26.

### REFERENCE NUMERAL LIST

1 Deep rolling head
2 Guide roller
3 Work roller
4 Radius or recess
5 Bearing trunnion
6 Direction of circumference
7 Cage
8 Holding plate
9 Cage roller
10 Cage retainer
11 Rotational axis
12 Rotational axis
13 Axial direction
14 Holding plate
15 Oblong slot
16 Recess
17 Recess
18 Centre axis
19 Centre axis
20 Bore hole
21 Longitudinal groove
22 Circumferential flange
24 Centre
25 Circumferential surface
26 Contact area

1. A deep rolling head of a deep rolling unit for deep rolling of radii or recesses at the bearing trunnions of crankshafts with the help of work rollers which are held on both sides of the contact point in the direction of circumference at the deep rolling head with the bearing trunnion from cages and can be rotated freely in there, whereby the cages are held at the deep rolling head by cage retainers,
comprising at least one cage of the deep rolling head designed as a cage roller and one stopping device provided for the work roller.

2. The deep rolling head according to claim 1, wherein the cage roller is designed as a roller bearing or as a carrier roller upon which a roller bearing is mounted.

3. The deep rolling head according to claim 1, wherein the cage roller is designed as a carrier roller upon which a slide bearing is mounted.

4. The deep rolling head according to claim 2, wherein a contact area of the cage roller is cylindrically equipped with the work roller.

5. The deep rolling head according to claim 2, wherein a contact area of the cage roller is concavely equipped with the work roller.

6. The deep rolling head according to claim 1, wherein the cage roller in the deep rolling head is mounted with axial play.

7. The deep rolling head according to claim 1, wherein the inclinations of the rotational axes of the cage roller and the work roller are substantially equal.

8. The deep rolling head according to claim 1, wherein the rotational axis of the cage roller is horizontal.

9. The deep rolling head according to claim 1, further comprising a cage retainer having two cage rollers.

10. The deep rolling head according to claim 1, wherein each cage roller has its own cage retainer.

11. The deep rolling head according to claim 1, wherein the cage roller comprises a carrier roller and a roller bearing, wherein the roller bearing is mounted on the carrier roller.

12. The deep rolling head according to claim 1, wherein the cage roller comprises a roller bearing.

13. The deep rolling head according to claim 3, wherein a contact area of the cage roller is cylindrically equipped with the work roller.

14. The deep rolling head according to claim 3, wherein a contact area of the cage roller is concavely equipped with the work roller.
